(19) United States
(12) Patent Application Publication
(10) Pub. No.: US 2011/0225821 A1
(43) Pub. Date: Sep. 22, 2011

(54) Process of electrically connecting electrodes of a photovoltaic panel

(75) Inventors: Yi-Wen Tai, Hsin Chu City (TW); Cheng Pei Huang, Taipei City (TW)

(73) Assignee: DuPont Apollo Ltd.

(21) Appl. No.: 13/064,250

(22) Filed: Mar. 14, 2011

Related U.S. Application Data
(60) Provisional application No. 61/314,764, filed on Mar. 17, 2010.

(51) Int. Cl. H01R 43/00

(52) U.S. Cl. 29/877; 29/884

(57) ABSTRACT

A process of electrically connecting electrodes of a photovoltaic panel is provided, comprising: applying a conductive adhesive film on the electrodes of the photovoltaic panel, wherein the conductive adhesive film comprising an insulating adhesive layer and electrical conductive particles distributed in the insulating adhesive layer; providing a metal strip along the conductive adhesive film; and performing an electrical connection process between the metal strip and the electrodes via the conductive adhesive film.

### BACKGROUND OF THE INVENTION

1. Field of the Invention

The present invention relates generally to a process of electrically connecting electrodes of a photovoltaic panel for converting solar energy to electrical energy and deriving an output from the photovoltaic panel.

2. Description of the Related Art

Conventionally, a photovoltaic panel has lead wire soldering regions at both ends for converting solar energy to electrical energy and deriving an output from the photovoltaic panel. In the lead wire soldering regions, a number of solder bumps serving as positive and negative electrodes are formed in a row at regular intervals. Lead wires are connected to the solder bumps, so that an output of the photovoltaic panel can be derived. For example, in U.S. Pat. No. 6,357,649, a method and an apparatus which can automatically connect lead wires to a row of solder bumps formed in a lead wire soldering region of a photovoltaic panel are provided. Thereafter, the lead wires can be connected to a terminal box attached to the surface of the photovoltaic panel.

Bumps can conventionally be soldered and secured by hand or an automatic soldering apparatus such as ultrasonic soldering. Nevertheless, no matter whether the soldering is carried out by hand or an automatic soldering apparatus, some of the solder bumps may be missed or dislocated because of the malfunction of the apparatus, and therefore results in a photovoltaic breakage. In addition, when lead wires are arranged along the row of the solder bumps and the soldering iron is pressed against the lead wires from above, weights are hung from the ends of the lead wires to apply tension to the lead wires so that the lead wires can be prevented from shifting or wrinkling. The lead wires soldered between solder bumps are strained because of this step.

U.S. Pat. No. 6,402,881 provides a process of electrically interconnecting electrodes of a solar cell, wherein the interconnects of the solar cell employ copper strips and are secured to the solar cell by a silver-silicone conductive paste. By this process, the use of the solder bumps can be eliminated. Nevertheless, the silver-silicone conductive paste needs to be cured in order to form an electrical interconnection.

In view of the above, there has been a need for a process of electrically connecting electrodes of a photovoltaic panel which can reduce or eliminate the breakage problems due to the solder bumps and is simpler.

### BRIEF SUMMARY OF THE INVENTION

An object of the present invention is to eliminate photovoltaic breakage caused by missed or dislocated solder bumps formed in a metal wire soldering region of a photovoltaic panel.

An object of the present invention is to provide electrical connection for a photovoltaic panel by use of a conductive adhesive film on the electrodes of the photovoltaic panel.

An object of the present invention is to provide a simpler process to provide an electrical connection for a photovoltaic panel by applying a conductive adhesive film on the electrodes of the photovoltaic panel.

According to the subject invention, a conductive adhesive film is provided on the electrodes of the photovoltaic panel so that an electrical conductive member such as a metal strip can be attached to by the adhesive property of the conductive adhesive film or by a soldering process.

According to the subject invention, a process of electrically connecting electrodes of a photovoltaic panel, comprising: applying an conductive adhesive film on the electrodes of the photovoltaic panel, wherein the conductive adhesive film comprises an insulating adhesive layer and electrical conductive particles distributed in the insulating adhesive layer; providing a metal strip along the conductive adhesive film; and performing an electrical connection process between the metal strip and the electrodes via the conductive adhesive film.

The step of the electrical connection process comprises a lamination step applied to the photovoltaic panel. The lamination step is applied after the metal strip is provided along with the conductive adhesive film so that the electrical conductive particles distributed in the conductive adhesive film are pressed and contact with each other to form an electrical connection between the metal strip and the electrodes of the photovoltaic panel.

The process of the invention eliminates the necessity of solder bumps for electrical connection of a photovoltaic panel and therefore no resulting photovoltaic panel malfunction problems may occur by missing or dislocating the solder bumps. In addition, since the solder bump or the curing process used in the conventional electrical connecting process for photovoltaic panel are no longer necessary according to the present invention, the process can be more productive and cost efficient. Moreover, the yield may be improved.

### BRIEF DESCRIPTION OF THE DRAWINGS

FIG. 1 is a perspective view of an embodiment of the photovoltaic panel of the present invention on which the conductive adhesive films and the metal strip are formed.

FIG. 2 is a cross section view of a part of the embodiment depicted in FIG. 1.

Like reference numerals refer to corresponding parts throughout the several drawings. Dimensions are not drawn to scale.

### DETAILED DESCRIPTION OF THE INVENTION

Features from different embodiments described below are examples of the elements recited in the claims and can be combined together into one embodiment without departing from the scope of the claims.

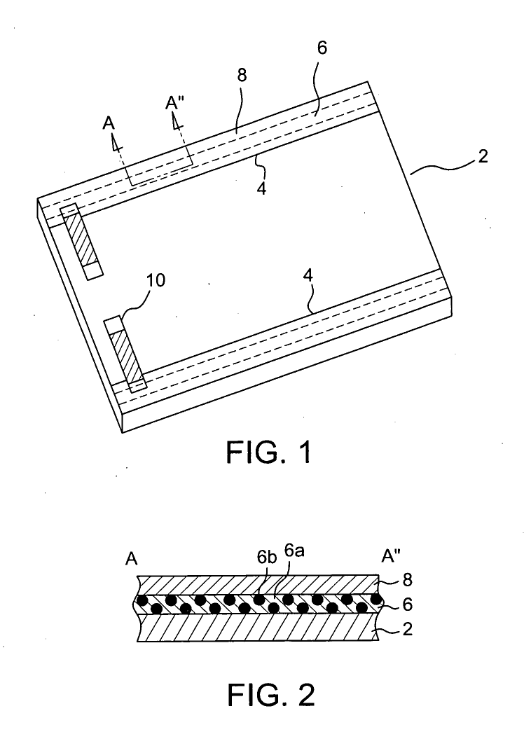

FIG. 1 illustrates a photovoltaic panel 2, which are electrically connected by a conductive adhesive film 6 and a metal strip 8 placed thereon on the electrodes of the photovoltaic panel 2 in the wire soldering regions 4. FIG. 2 is a cross section view of a part of the photovoltaic panel 2 depicted in FIG. 1.

The process of the invention will be described in detail hereinafter, directed to the use of the conductive adhesive film containing the electrical conductive particles.

The electrical connecting process involves an application of a conductive adhesive film 6 on the electrodes of the photovoltaic panel 2. In one embodiment, the conductive adhesive film 6 can be but not limited to an anisotropic conductive adhesive film. The conductive adhesive film 6 comprises an insulating adhesive layer 6a and electrical conductive particles 6b distributed in the insulating adhesive layer 6a. The electrical conductive particles 6b can be metal powders made of Ni, Au, Ag, Tin, or an alloy of these, or polymer or plastic powders whose surfaces have been metal-plated thereon, uniformly distributed in the insulating adhesive layer 6a. It is preferable for the size of the electrical conductive particles 6b to be about 3 to about 10 μm according to the width of the metal strips. In one embodiment, the conductive adhesive film 6 is applied to the electrodes of the photovoltaic panel 2 by its adhesive property, which can be derived from the insulating adhesive layer 6a. In one embodiment, the conductive adhesive film 6 is a conductive adhesive tape, which is applied to the electrodes of the photovoltaic panel 2 by its adhesive property, and the metal strip 8 is placed thereon. The metal strip 8 is fixed on the electrodes of the photovoltaic panel 2 via the conductive adhesive film 6. Then, an electrical connection process is performed between the metal strip 8 and the electrodes via the conductive adhesive film 6. The electrical connection process comprises a lamination step applied to the photovoltaic panel 2 after the metal strip 8 is provided along with the conductive adhesive film 6.

During the lamination step, the electrical conductive particles 6b of the conductive adhesive film 6 are pressed so as to contact with the adjacent electrical conductive particles 6b and form a conductive connection between the metal strips 8 and electrodes of the photovoltaic panel 2.

In one embodiment, the metal strip 8 is attached to the conductive adhesive film 6 by the adhesive property of the conductive adhesive film 6. In one embodiment, metal strips or wires made of solder-plated copper foil or the like can be placed on the conductive adhesive film 6 by a process conventionally useful for soldering a metal strip on solder bumps, as described in U.S. Pat. No. 6,357,649. In other words, a process similar to the metal strip soldering technology can be applied in the subject invention to place the metal strips 8 along the conductive adhesive film 6. According to the technology, the metal strips 8 can be pressed on the conductive adhesive film 6 by a soldering iron, and the metal strips 8 can be optionally heated from above. The related process described in U.S. Pat. No. 6,357,649 is incorporated herein in its entirety by reference thereto. The metal strip can be made of but not limited to silver, copper or other similar materials.

The photovoltaic panel 2 in the disclosed embodiment can include a structure made by but not limited to amorphous silicon, III-V, II-VI, or any other suitable material grown on glass.

After the metal strips 8 made of copper foil or the like are applied to the positive and negative electrodes with the conductive adhesive film placed thereon, a part of the metal connect can be connected to a terminal box attached to the surface of the photovoltaic panel via another metal strip 10 in order to derive an output. The metal strip 10 can be surrounded with an insulating material except two ends.

When producing multiple photovoltaic panels, a plurality of photovoltaic modules may be formed on single substrate, and the single substrate is cut at the dividing regions to form a plurality of photovoltaic panels and the metal strips are connected to the metal wire soldering regions on both sides of each photovoltaic panel. In other words, the conductive adhesive film are first formed in the metal wire soldering regions on both sides of the divided photovoltaic panel, and thereafter the metal connects are placed along the conductive adhesive film.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

We claim:

1. A process of electrically connecting electrodes of a photovoltaic panel, comprising:
applying a conductive adhesive film on the electrodes of the photovoltaic panel, wherein the conductive adhesive film comprising an insulating adhesive layer and electrical conductive particles distributed in the insulating adhesive layer;
providing a metal strip along the conductive adhesive film; and
performing an electrical connection process between the metal strip and the electrodes via the conductive adhesive film.

2. The process of claim 1, wherein the conductive adhesive film is an anisotropic conductive adhesive film.

3. The process of claim 1, wherein the electrical conductive particles are metal powders.

4. The process of claim 3, wherein the material of the metal powder is selected from the group consisting of Ni, Au, Ag, and Tin.

5. The process of claim 1, wherein the electrical conductive particles are polymer powders whose surfaces have been metal-plated thereon.

6. The process of claim 1, wherein the electrical conductive particles are plastic powders whose surfaces have been metal-plated thereon.

7. The process of claim 1, wherein the size of the electrical conductive particles is about 3 to about 10 μm.

8. The process of claim 1, wherein the conductive adhesive film is a conductive adhesive tape.

9. The process of claim 1, wherein the metal strip is attached to the conductive adhesive film by adhesion.

10. The process of claim 1, wherein the conductive adhesive film is applied on the electrodes of the photovoltaic panel by adhesion.

11. The process of claim 1, wherein the step of the electrical connection process comprises a step of laminating the photovoltaic panel after the metal strip is provided along with the conductive adhesive film so as to press the conductive adhesive film and contact the electrical conductive particles with each other.

12. The process of claim 1, wherein the material of metal strip is selected from the group consisting of silver and copper.
